(19) United States
(12) Patent Application Publication
(10) Pub. No.: US 2010/0135538 A1
(43) Pub. Date: Jun. 3, 2010

(54) METHOD AND DEVICE FOR THE AUTOMATED AUTHENTICATION OF A SET OF POINTS

(75) Inventor: Claude Barral, St Savournin (FR)

Correspondence Address: BUCHANAN, INGERSOLL & ROONEY PC, POST OFFICE BOX 1404, ALEXANDRIA, VA, 22313-1404, US

(73) Assignee: Gemalto SA, Meudon (FR)

(21) Appl. No.: 12/598,639

(22) PCT Filed: Apr. 14, 2008
(86) PCT No.: PCT/EP08/54492

§ 371 Date: Nov. 3, 2009

(30) Foreign Application Priority Data
May 11, 2007 (EP) 07301034.0

(51) Int. Cl. G06K 9/46

(52) U.S. Cl. 382/115; 382/203

(57) ABSTRACT

The invention relates to a method and to an automated device for the authentication of a set of candidate points relative to a set of reference points. The present invention is insensitive to unavoidable translation, rotation and scaling occurring upon successive but independent acquisitions of, for example, of fingerprints.

Generally speaking, the invention relates to the techniques relating to the automated authentication of a set of characteristic points with a very high degree of reliability.

More precisely, and according to a first aspect, the invention relates to a method of authentication of a scatter plot including at least the operation consisting in identifying, in this scatter plot, a set of characteristic points which will be called minutiae in a number above 3.

The authentication of a set of points with respect to another is indispensable in many fields. Among these, we can mention:

Biometry. The utilization of biometric prints such as fingerprints, for identifying a person and for example authenticating the documents she shows, has a widely recognized efficiency which no longer needs to be demonstrated.

Astronomy. As a matter of fact, the identification of the celestial bodies makes it possible to find one's position on the globe, and to find one's way.

These techniques and more particularly the automation of recognition meets several difficulties which cannot be solved today but by resorting to powerful computers.

More particularly, the diagram of a scatter plot according to the present techniques is sensitive to various transformations and more particularly translations, rotations and scaling.

These transformations result from the changes in the position of the acquisition means (digital print reader, picture camera, camera) upon the acquisition. As a matter of fact, two consecutive acquisitions will never be identical since the acquisition device will never be positioned exactly at the same place, the subject or the target of the acquisition will never be positioned exactly at the same place either, and the environmental parameters which can affect the acquisition must be added thereto.

These interferences cause parasitic transformations which are essentially translations and rotations.

Variations in the distance between the target of the acquisition and the acquisition means also cause parasitic transformations, essentially scaling.

In addition, the indexing of the characteristic points of a scatter plot in the solutions known in the state of the art requires the positioning of the scatter plot in an ortho-normal index. This operation requires numerous calculations, among other things intended to centre the ortho-normal index on the scatter plot concerned.

In this context, the present invention intends to provide an authentication method requiring no indexing of the scatter plot in an ortho-normal index, and wherein the representation of the scatter plot is insensitive at least to one of these transformations, so that it can be implemented on less powerful computers.

These authentication methods are based on a match of a candidate with a reference.

The first step will then always be a so-called enrolment step consisting in the recording of the value which will subsequently be used as a reference. This particular step must be carried out whenever possible, under correct safety conditions so that this value can subsequently be relied upon.

The enrolment is divided into

At least an acquisition step

At least an extraction step

At least a processing step

At least a storage step (generally in a non volatile memory).

The second step is the authentication step proper. This step consists in matching a candidate value with a reference value saved during the enrolment.

The authentication can be divided into:

At least an acquisition step

At least an extraction step

At least a processing step

At least a storage step (generally in a volatile memory)

At least a match step (generally called MATCH)

At least a retrieval of the result.

The authentication method according to the invention provides a solution which makes it possible to automatise and embed the steps of processing and match in devices having small resources in storage as well as in calculation capacity.

For this purpose, the authentication method of the invention complying with the general definition given in the above preamble is mainly characterised in that it further includes the following operation:

grouping minutiae three by three so as to form non flat triangles, each of which has three distribution points as apexes. “Non flat” triangle means a triangle, the three apexes of which are not aligned.

associating each selected triangle with a piece of information on the diameter of the circumscribed circle and storing such information;

defining, for each selected triangle, two pieces of information representative of two ratios implying the three angles of the triangle taken two by two.

In practice, the scatter plot can be represented by the list of the triplets formed of the three pieces of information obtained during the two previous steps for each selected triangle. In a particularly advantageous case, the non flat triangles are selected according to Delaunay's triangulation method.

A device according to the present invention further includes:

automated recognition means for identifying in the bi-dimensional picture, a bi-dimensional distribution of points each of which corresponds to the position of a characteristic point in a scatter plot;

programmed calculation means:
for selecting, in this distribution of characteristic points, a plurality of non flat triangles, each of which has three points of the distribution as apexes,
for associating with each selected triangle one piece of information on the diameter of the circumscribed circle and storing the latter,
defining, for each selected triangle ABC, two pieces of information respectively representing two ratios implying the three angles of the triangle taken two by two, and
a non volatile memory for storing, as a representation of said print, a list of the triplets formed the three pieces of information obtained during the two previous steps, for each selected triangle.

Preferably, the device will also have a volatile memory making it possible to temporarily store the triplets or the lists of triplets during the various calculations.

Preferably, the programmed calculation means are further programmed:

for matching the set of the triplets from a candidate scatter plot (NPC) with the set of the triplets from a reference scatter plot (NPR) previously stored in the non volatile memory,

for counting the triplets in the candidate scatter plot, the values of which vary with one of the triplets of the reference print in proportions under predefined thresholds.

As a matter of fact, the NPC triplet (Angle1-NPC, Angle2-NPC, Diam-NPC) will be selected only if a NPR triplet (Angle1-NPR, Angle2-NPR, Diam-NPR) exists for which:

Angle1-NPC and Angle1-NPR vary in proportions under a threshold S1.

Angle2-NPC and Angle2-NPR vary in proportions under a threshold S2.

Diam-NPC and Diam-NPR vary in proportions under a threshold S3.

for assimilating, or not, the candidate scatter plot with the reference scatter plot, depending on whether the number of previously counted triplets of NPC, as compared with the first number of triplets represents or does not represent a proportion at least equal to a determined threshold-acceptation threshold.

Other characteristics and advantages of the invention will appear clearly from the description which is given hereinafter as an indication and not a limitation, and referring to the drawings, wherein:

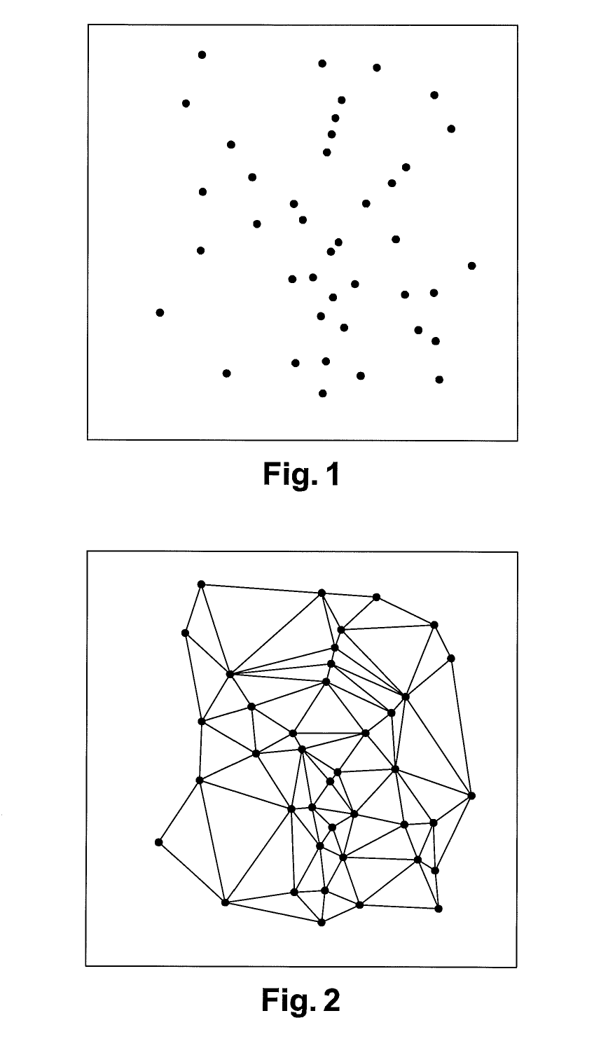

FIG. 1 shows a set of characteristic points (minutiae) from a scatter plot not shown;

FIG. 2 shows an example of non flat triangles network according to the invention applied to the minutiae of FIG. 1;

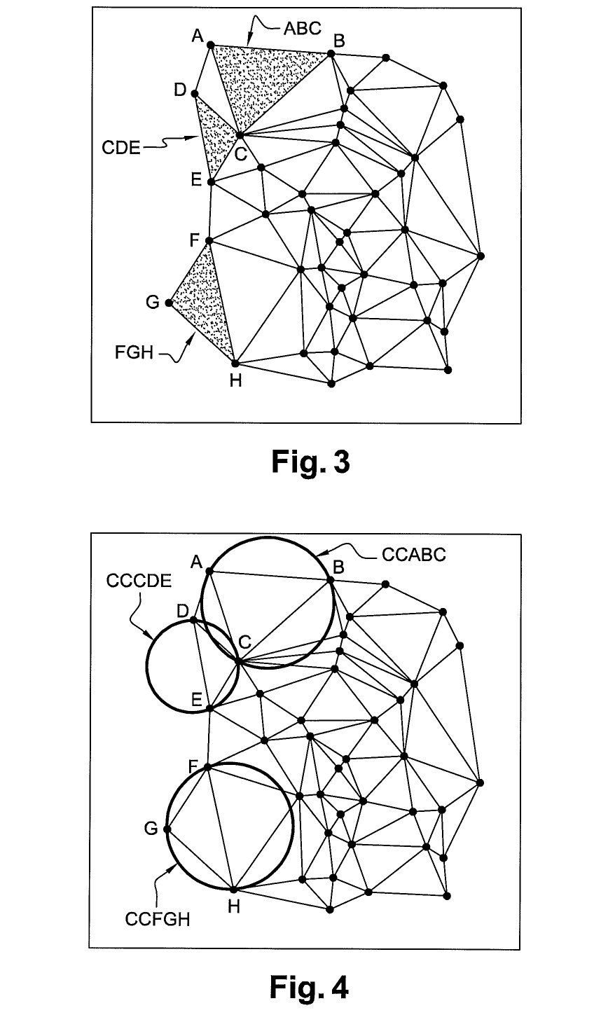

FIG. 3 shows three triangles among the set of those in FIG. 2;

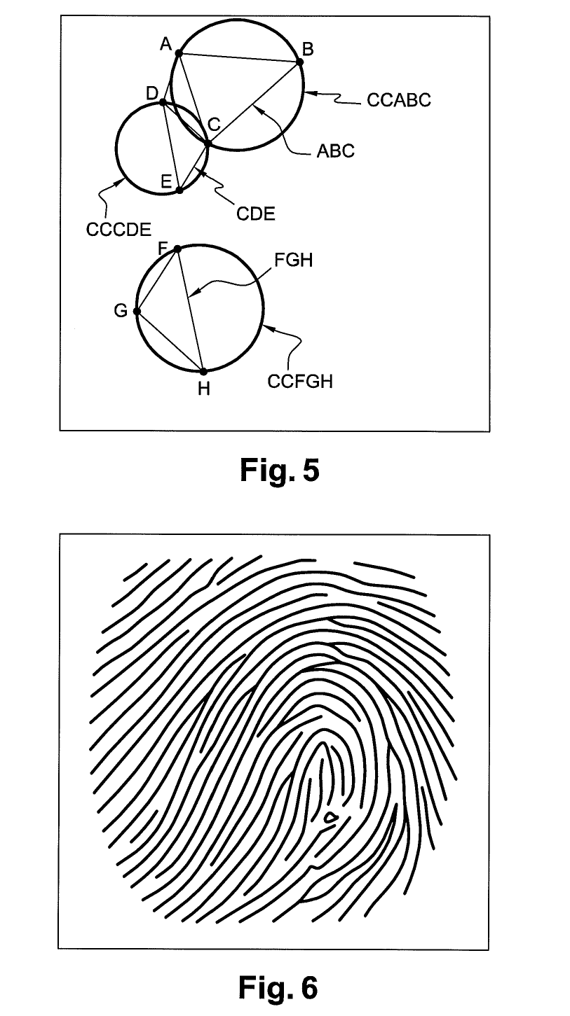

FIG. 4 shows the triangles shown in FIG. 4 with their respective circumscribed circles;

FIG. 5 reduces the scatter plot from which the minutiae represented in FIG. 1 are coming to the three triangles shown in FIG. 3 and to their circumscribed circles shown in FIG. 4;

FIG. 6 shows an enlarged view of a fingerprint;

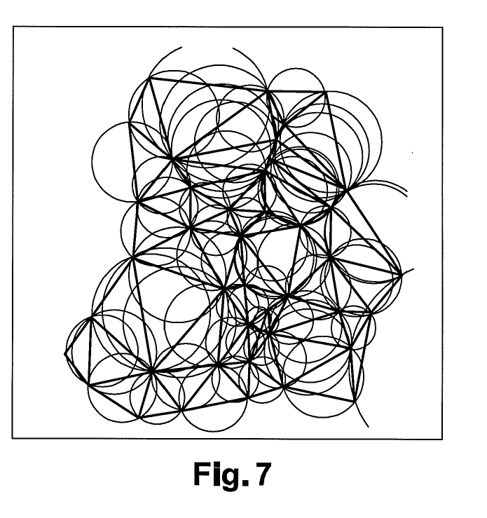

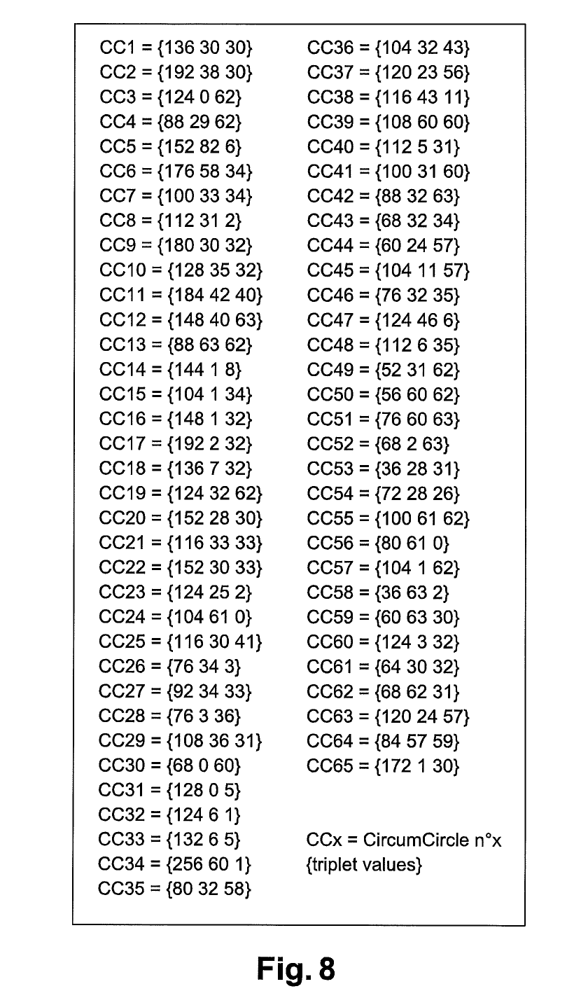

FIG. 7 shows the minutiae from the fingerprint in FIG. 6, with the minutiae being connected together so as to form non flat triangles and each of these triangles having a circumscribed circle;

FIG. 8 shows the list of triplets from triangle data and circle data in FIG. 7. This list of triplets forms a signature of the fingerprint in the FIG. 6.

As mentioned previously, the invention relates to an authentication method implementing a scatter plot.

In a known way, an authentication method of this type includes, during its acquisition phase, an identification operation which consists in identifying in the scatter plot to be acquired a set of characteristic points (called minutiae in the present document), generally in the number of a few dozens.

According to the invention, this phase of acquisition which leads to obtaining a representation of the scatter plot further includes assimilation, selection, association, definition and representation operations.

The assimilation operation consists in assimilating the set of minutiae previously identified in the print with a bi-dimensional distribution of points such as A to K.

FIG. 1 illustrates the assimilation of the set of characteristic points from a scatter plot with a bi-dimensional representation of these minutiae.

In the prior art, in the digital print, minutiae are conventionally composed of line intersections.

Similarly, in another field which is that of the analysis of celestial bodies, the most shining bodies are often used as characteristic points in a portion of the sky. In any diagram, the characteristic points will generally be isolated points so that they will not be mistaken for their neighbors. Some groups of points can be chosen because of a particularly identifiable arrangement.

All these point selection methods required the scatter plot to be sufficiently important for the number of characteristic points to be sufficient.

According to the invention, any point can become a characteristic point, since the “selection” of the points meeting the quality criteria is replaced by the selection of triangles enabling the calculations. Then, it is possible to process scatter plots which are smaller than in the prior art by adapting the triangle selection methods.

The selection operation consists in selecting in this distribution of points, a plurality of non flat triangles each of which has three points on the bi-dimensional distribution of points as apexes.

Delaunay's triangulation technique gives further results but many other methods can be implemented so long as they exclude flat triangles.

When the number of minutiae is very important, a method may consist in refusing any triangle having a common apex with an already saved triangle and flat triangles.

Another method can consist in excluding flat triangles and partially or totally circumscribed triangles in already saved triangles. Another method may consist in excluding flat triangles and triangles containing minutiae in addition to their three apexes.

In the case where the number of minutia is very small, the selection may be made for example by excluding only flat triangles.

Several possibly cumulated criteria can be adopted to optimize this selection operation.

FIG. 2 illustrates the selection of triangles resulting from the points in FIG. 1 according to Delaunay's method.

The operation of association consists in associating to each selected triangle a piece of information DIAM on the diameter of the circumscribed circle.

FIG. 4 illustrates the association with three particularly identified triangles in FIG. 3 of their respective circumscribed circles. Then, this operation can associate with the triangle ABC, the squared diameter of the circumscribed circle CCABC, with the triangle CDE, the squared diameter of the circumscribed circle CCCDE, with the triangle FGH, the squared diameter of the circumscribed circle CCFGH.

The definition operation consists in defining, for each selected triangle ABC, two pieces of information (Angle1 and Angle2) respectively representing two ratios implying the three angles of the triangle taken two by two. In a preferred embodiment, this step will consist in defining, for each selected triangle ABC, an apex A which should be used as an index and store the angles Angle1=TetaA-TetaB as well as Angle2=TetaA-TetaC.

Considering that:

TetaA is the internal angle of the triangle formed in A by the intersection of segments [BA] and [CA]

TetaB is the internal angle of the triangle formed in B by the intersection of segments [AB] and [CB]

TetaC is the internal angle of the triangle formed in C by the intersection of segments [BC] and [AC].

A particular embodiment of the invention consists in applying it to the field of biometry.

As a matter of fact, the field of biometry particularly needs quick and simple means for authenticating a person, with a high reliability.

An authentication based on biometry starts with a step of acquisition and a step of extraction.

The acquisition is the step which consists in capturing the biometric data at a given time. In the case of most biometry, this step is executed in the capture of an image and this is the case among other things for digital prints, face, retinal, iris and many other recognitions.

However, this acquisition can take various forms for example a recording for voice recognition, video recording for behavior recognition, combined motion and pressure recording for fingerprint recognition.

When the acquisition is completed, the step of extraction makes it possible to isolate characteristic points in this acquisition. In the case of fingerprints, these characteristic points are, among others, line intersections, line ends or islands in a line.

The result of the extraction step, applied to the acquisition of fingerprint in FIG. 6, gives a set of points which can be compared to that of FIG. 1.

After selecting triangles connecting these points and calculating their respective circumscribed circles, a diagram which can be compared to that shown in FIG. 7 is obtained while storing a triplet per triangle ABC and each triplet containing one piece of information on the diameter of the circle (here the square root) and angles Angle1=TetaA-TetaB as well as Angle2=TetaA-TetaC, the fingerprint of FIG. 6 can be represented by the list of triplets in FIG. 8.

This step is for example the enrolment step and the list of triplets obtained can be stored in a chip card.

{102;27;94} {152;13;79}

{81;84;29} {192;53;13}

{141;63;66} {458;36;27}

{391;28;48} {73;21;89}

{423;7;13} {180;45;75}

During the authentication, the user will submit his or her finger to an acquisition through a digital fingerprint reader. This new fingerprint also called candidate fingerprint will, for example, be sent to a portable calculation unit and processed as described above in order to show it with a sequence of triplets.

{143;62;68} {155;17;76}

{102;15;6} {210;54;88}

{19;91;42} {70;23;86}

{85;82;27} {28;85;95}

{181;29;85} {394;27;50}

{327;16;33} {192;55;14}

The set of characteristic points which made it possible to obtain this list of triplets could have been obtained not directly from the digital fingerprint but a representation thereof in any form, provided it is possible for the portable calculation unit to make a bi-dimensional representation so that the triplets can be calculated.

It should be noted that the number of triplets depends on the number of triangles selected during the selection step. Then, two acquisitions will exceptionally have exactly the same number of triplets.

When the list of triplets, also called candidate triplets, is obtained, it will be stored in the portable calculation unit volatile memory.

The authentication system is for example adjusted as follows:

Threshold-acceptation=60%:60% of the triplets of the reference fingerprint should be found in the candidate fingerprint.

S1=5: the “Angle1” values of the two triplets compared should vary by less than 5.

S2=5: the “Angle2” values of the two triplets compared should vary by less than 5.

S3=7: the “DIAM” values of the two triplets compared should vary by less than 7.

The portable calculation unit will request the chip card to send the reference triplets and will start matching them with those of the candidate fingerprint.

Then, the match proper can start.

By matching the triplets {102; 27; 94} and {143; 62; 68}, 102 and 143 vary by more than 7 (value of S3). The triplet {102; 27; 94} is not retained as “similar” to the triplet {143; 62; 68} and the analysis goes on.

After numerous matchs, the portable calculation unit will compare the triplets {81; 84; 29} and {85; 82; 27}: 81 and 85 vary by 4, which is far less than or equal to S3, 84 and 82 vary by 2, which is far less than or equal to S2, 29 and 27 vary by 2, which is far less than or equal to S1. Thus, both triplets vary in proportions smaller than or equal to the predefined thresholds S1, S2, S3.

Then, this candidate triplet will no longer belong to the following analysis and the similitude count is incremented by 1.

The continuation of the analysis is shown as follows:

Finally, the counter contains the value seven for a reference fingerprint composed of 10 triplets which means 70% of the reference fingerprint has been found in the candidate fingerprint. This threshold is higher than the Threshold-acceptation value fixed at 60%.

The candidate fingerprint is then authenticated as belonging to the chip card holder.

Another particular embodiment of the invention consists in applying it to astronomy.

As a matter of fact, when embedded in a portable telephone provided with a picture camera, the invention will enable the following application.

According to the invention, it is easy to process the whole or a part of the map of the celestial bodies which can be seen by night, from a particular territory or a larger area on the globe. Once these pieces of information are converted into a list of triplets, this map can be considered as a reference data.

Then, it is possible for the user to take a picture of the stars that he or she can see. The application will process such data to obtain a series of triplets considered as candidates. The application will then try to authenticate the part of the sky on the general reference map which the candidate portion corresponds to. This will make it possible, for example, to identify the place where the picture was taken, in the case where the user is lost. An other utilization can be the identification of celestial bodies or groups of celestial bodies (constellations, etc.) that the user sees if such data are added to the general reference map.

These embodiments must be considered as exemplary applications and not limitations of the present invention. The present document covers the whole utilization of the present invention in every field where a match of characteristic points is made with reference points.

It should be noted that the present invention can be used in a partial mode so as to store sets of points in the form of triplets.

A particular utilization of the invention consists of its application to scatter plots already stored in another form than that of the invention. In this case, the invention will convert the scatter plot in the form of triplets.

The solution according to the invention makes it possible to significantly increase the performances of the match step with respect to the solutions known in the state of the art and the technique.

The present invention also makes it possible to make an authentication with sets of characteristic points which are less important than in the prior art. As a matter of fact, the present invention uses triangles resulting from characteristic points and not directly the characteristic points, and this makes it possible to obtain a number of triangles much higher than the number of points if the method of selection of triangles is selected carefully. This characteristic makes it possible for the present invention to authenticate sets of points which were impossible to authenticate so far because of the low number of characteristic points thereof.

1. An authentication method implementing a scatter plot, and a set of characteristic points of said scatter plot, said characteristic points being called minutiae, said method including an extraction operation that extracts a signature from the set of characteristic points, wherein said extraction operation includes the operations steps of:
grouping the minutiae 3 by 3 so as to form non flat triangles having 3 of the minutiae as apexes.
associating with each selected triangle one ones of the triangles with a piece of information DIAM on the diameter of a corresponding circumscribed circle;
defining, for each selected triangle, two pieces of angle information, Angle1 and Angle2, respectively representing two ratios involving the three angles of said triangles taken two by two.

2. A method according to claim 1, wherein said set of characteristic points is represented by the list of triplets formed by Diam, Angle1, Angle2 for each selected triangle.

3. A method according to claim 1, wherein the non flat triangles are selected according to Delaunay's triangulation method.

4. A method according to claim 2, wherein said obtained triplets are stored in a memory.

5. A method according to claim 1, including a step of matching a set of candidate characteristic points with a set of reference characteristic points, said step of match including at least a step consisting in counting the triplets of said set of candidate characteristic points, the values of which vary with one of the triplets of said set of reference characteristic points, in proportions lower than predefined thresholds; and
a step of validation consisting in checking that the number obtained in the counting step exceeds a predefined threshold.

6. A method according to claim 1, wherein each set of characteristic points is a biometric print.

7. A method according to claim 1, wherein each set of characteristic points is a space cartography of a part of the sky.

8. A method according to claim 1, wherein each set of characteristic points is representative of a person's behavioral data.

9. An authentication device including at least acquisition means that forms a digitalized bi-dimensional image of a set of characteristic points, said device comprising:
automatic recognition means for identifying in the bi-dimensional picture, a bi-dimensional distribution of points, each of which corresponds to the location of a minutia;
calculation means programmed for:
selecting, from this distribution of points, a plurality of non flat triangles each of which has 3 points of the distribution as apexes,
associating to each selected triangle a piece of information DIAM on the diameter of the circumscribed circle;
defining, for each selected triangle, two pieces of information, Angle1 and Angle2, respectively representing two ratios involving the angles of said triangle, taken two by two; and
a non volatile memory for storing, as a representation of said set of characteristic points, a list of triplets formed of at least Diam, Angle1, Angle2 for each selected triangle.

10. An authentication device according to claim 9, wherein the programmed calculation means are further programmed for:
matching the set of triplets, originating from a set of candidate characteristic points to the set of triplets originating from a set of reference characteristic points previously stored in the non volatile memory,
counting the triplets in the set of candidate characteristic points the values Diam, Angle1 and Angle2 of which vary with one of the triplets of the reference print in proportions lower than predefined thresholds;
assimilating, or not, a set of candidate characteristic points with the set of reference characteristic points depending on whether the number of previously counted triplets, as compared to the first number of triplets, represents or does not represent a proportion at least equal to the determined threshold.

11. A method according to claim 2, wherein the non flat triangles are selected according to Delaunay's triangulation method.

12. A method according to claim 3, wherein said obtained triplets are stored in a memory.

13. A method according to claim 2, further including a step of matching a set of candidate characteristic points with a set of reference characteristic points, said step of match including at least a step consisting in counting the triplets of said set of candidate characteristic points, the values of which vary with one of the triplets of said set of reference characteristic points, in proportions lower than predefined thresholds; and
a step of validation consisting in checking that the number obtained in the counting step exceeds a predefined threshold.

14. A method according to claim 3, further including a step of matching a set of candidate characteristic points with a set of reference characteristic points, said step of match including at least a step consisting in counting the triplets of said set of candidate characteristic points, the values of which vary with one of the triplets of said set of reference characteristic points, in proportions lower than predefined thresholds; and
a step of validation consisting in checking that the number obtained in the counting step exceeds a predefined threshold.

15. A method according to claim 4, further including a step of matching a set of candidate characteristic points with a set of reference characteristic points, said step of match including at least a step consisting in counting the triplets of said set of candidate characteristic points, the values of which vary with one of the triplets of said set of reference characteristic points, in proportions lower than predefined thresholds; and
a step of validation consisting in checking that the number obtained in the counting step exceeds a predefined threshold.

16. A method according to claim 2, wherein each set of characteristic points is a biometric print.

17. A method according to claim 3, wherein each set of characteristic points is a biometric print.

18. A method according to claim 4, wherein each set of characteristic points is a biometric print.

19. A method according to claim 5, wherein each set of characteristic points is a biometric print.

20. A method according to claim 2, wherein each set of characteristic points is a space cartography of a part of the sky.
